(19) United States
(12) Patent Application Publication
(10) Pub. No.: US 2026/0072510 A1
(43) Pub. Date: Mar. 12, 2026

(54) FACIAL HAPTIC DEVICE AND APPLICATIONS

(71) Applicant: The Research Foundation for The State University of New York, Albany, NY (US)

(72) Inventor: Aishwari TALHAN, Albany, NY (US)

(21) Appl. No.: 19/325,169

(22) Filed: Sep. 10, 2025

Related U.S. Application Data
(60) Provisional application No. 63/692,813, filed on Sep. 10, 2024.

(51) Int. Cl. G06F 3/01; G06F 3/04842; G06F 3/16; H04N 7/15

(52) U.S. Cl. CPC G06F 3/016; G06F 3/011; G06F 3/04842; G06F 3/167; H04N 7/157

(57) ABSTRACT

Apparatuses, computer-implemented methods, computer program products, and computer systems deliver a mediated social touch (MST) to a user. Program code executing on one or more processors obtains an instruction to deliver the MST to the user. The program code controls a haptic device comprising one or more end effectors positioned proximate to at least one cheek of the user, where the user is wearing the haptic device, to deliver tactile feedback comprising the MST to the user via a portion of the one or more end effectors.

### CROSS-REFERENCE TO RELATED APPLICATION

The present invention claims priority from U.S. provisional patent application No. 63/692,813, filed Sep. 10, 2024, which is hereby incorporated herein by reference in its entirety for all purposes.

### FIELD OF DISCLOSURE

The subject matter described herein relates to electronic communications and virtual experiences, and more particularly to systems, apparatuses, and methods for implementing haptics into these scenarios.

### BACKGROUND

A haptic device is a human-computer interface that enables users to perceive and manipulate digital or virtual objects through the sense of touch by generating controlled tactile and kinesthetic feedback. Haptic devices employ mechanical actuation such as vibrations, resistance, and/or motion to simulate physical interactions.

Haptic devices in computing provide tactile feedback through vibrations, force, or motion to simulate the sense of touch, thereby enhancing digital interaction beyond visual and auditory channels. Haptic elements can be added to user interfaces, where they confirm actions on touchscreens and wearable devices. Haptic devices can also be used in virtual reality and gaming, where they create immersive experiences by simulating textures, resistance, or impacts. Haptic devices can also be used in professional training environments, such as surgical and flight simulations, where they offer realistic practice without risk.

Haptic devices can contribute to more natural, intuitive, and effective human-computer interaction. For example, haptic technologies support accessibility by conveying information through touch for users with visual impairments. Haptic devices play a role in remote control and teleoperation by allowing operators to experience physical feedback when manipulating robotic systems or machinery.

Communicating in a teleconference can be more challenging than in-person interactions because the lack of physical presence removes many nonverbal cues, such as body language, eye contact, and subtle gestures, which help convey meaning and regulate conversation flow. Audio and video limitations like poor sound quality, lag, or camera positioning can further distort speech or obscure facial expressions, leading to misunderstandings or interruptions. Participants may also find it harder to build rapport, sense engagement, or manage turn-taking without the natural feedback of an in-person setting. Additionally, technical issues such as connectivity problems, background noise, or device incompatibility can disrupt communication and reduce overall effectiveness. As a result, teleconferencing often requires more deliberate effort, clarity, and patience to ensure smooth and effective collaboration.

### SUMMARY

Shortcomings of the prior art can be overcome and benefits as described later in this disclosure can be achieved through the provision of a method for delivery of a mediated social touch (MST) to a user. Various examples of the method are described below, and the method, including and excluding the additional examples enumerated below, in any combination (provided these combinations are not inconsistent), overcome these shortcomings. The computer-implemented method can include obtaining, by one or more processors, an instruction to deliver the MST to the user. The method can include querying, by the one or more processors, a data repository, to identify haptic feedback comprising the MST, wherein the data repository comprises mappings of various MSTs to specific haptic feedback. The method can include controlling, by the one or more processors, a haptic device comprising one or more end effectors positioned proximate to at least one check of the user, wherein the user is wearing the haptic device, to deliver the haptic feedback comprising the MST to the user via a portion of the one or more end effectors.

Shortcomings of the prior art can be overcome and benefits as described later in this disclosure can be achieved through the provision of a computer system for delivery of a mediated social touch (MST) to a user. Various examples of the computer system are described below, and the computer system, including and excluding the additional examples enumerated below, in any combination (provided these combinations are not inconsistent), overcome these shortcomings. The computer system can include a haptic device. The haptic device can include a memory, one or more processors in communication with the memory, one or more actuators in communication with one or more processors, one or more end effectors, where each end effector is communicatively coupled to at least one actuator of the one or more actuators, and a housing to contain the memory, at least one processor of the one or more processors, and the one or more actuators. The housing can include a frame to position each end effector of the one or more end effectors proximate to a check of a wearer of the device; the user is the wearer of the device. The computer system is configured to perform a method which can include obtaining, by the one or more processors, an instruction to deliver the MST to the user; and controlling, by the one or more processors, at least one actuator of the one or more actuators to control at least one end effector of the one or more end effectors to deliver haptic feedback to the user, wherein the haptic feedback comprises the MST.

Shortcomings of the prior art can be overcome and benefits as described later in this disclosure can be achieved through the provision of a computer program product for delivery of a mediated social touch (MST) to a user. Various examples of the computer program product are described below, and the computer program product, including and excluding the additional examples enumerated below, in any combination (provided these combinations are not inconsistent), overcome these shortcomings. The computer program product can include one or more computer readable storage media and program instructions collectively stored on the one or more computer readable storage media readable by at least one processing circuit to perform various activities. The circuit obtains an instruction to deliver the MST to the user. The circuit queries a data repository, to identify haptic feedback comprising the MST, wherein the data repository comprises mappings of various MSTs to specific haptic feedback. The circuit controls a haptic device comprising one or more end effectors positioned proximate to at least one check of the user, where the user is wearing the haptic device, to deliver the haptic feedback comprising the MST to the user via a portion of the one or more end effectors.

Additional computer-implemented methods, apparatuses, computer systems, and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is an example of an apparatus described herein which is a head-wearable haptic device;

FIG. 2 illustrates aspects of an example of a vibration-based end effector which can be integrated into the apparatus of FIG. 1;

FIG. 3 illustrates aspects of an example of a pneumatic-based end effector which can be integrated into the apparatus of FIG. 1;

FIG. 4 is a block diagram illustrating elements of a technical architecture of the aspects of the examples described herein;

FIG. 5 is a workflow that illustrates various aspects of computer-implemented methods implemented with various aspects of the examples herein;

FIG. 6 is an example of a haptic keyboard graphical user interface the program code can display responsive to requests described in the workflow of FIG. 5;

FIG. 7 illustrates an interface of controls for a video conferencing application which integrates a haptic feedback selection as described in the workflow of FIG. 5;

FIG. 8 illustrates a computer system which integrates various aspects of the examples herein;

FIG. 9 illustrates various parts of a technical architecture which enables aspects of the workflow of FIG. 5;

FIG. 10 illustrates a block diagram of a resource in computer system, which is part of the technical architecture of certain embodiments of the technique; and

FIG. 11 illustrates a computer program product which includes one or more non-transitory computer readable storage media to store computer readable program code means or logic thereon to provide and facilitate one or more aspects of the technique.

### DETAILED DESCRIPTION

The accompanying figures, in which like reference numerals refer to identical or functionally similar elements throughout the separate views and which are incorporated in and form a part of the specification, further illustrate the present implementation and, together with the detailed description of the implementation, serve to explain the principles of the present implementation. As understood by one of skill in the art, the accompanying figures are provided for ease of understanding and illustrate aspects of certain examples of the present implementation. The implementation is not limited to the examples depicted in the figures.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

The terms “including” and “comprising”, as used herein, mean the same thing.

The terms “substantially”, “approximately”, “about”, “relatively”, or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. If used herein, the terms “substantially”, “approximately”, “about”, “relatively,” or other such similar terms may also refer to no fluctuations, that is, ±0%.

As used herein, “electrically coupled” and “optically coupled” refers to a transfer of electrical energy and light waves, respectively, between any combination of a power source, an electrode, a conductive portion of a substrate, a droplet, a conductive trace, wire, waveguide, nanostructures, other circuit segment and the like. The terms electrically coupled and optically coupled may be utilized in connection with direct or indirect connections and may pass through various intermediaries, such as a fluid intermediary, an air gap and the like.

As used herein, the term “memory” and “processor” can refer both to software and hardware memories. For example, as understood in the context of hardware, a microcontroller is a compact integrated circuit that combines a processor (CPU), memory, and various peripherals on a single chip. Meanwhile, as understood in the context of software, a memory is where program code can be stored for execution is typically called program memory (or non-volatile memory, such as Flash or ROM). In this software context, a memory holds instructions of a program so that the processor can fetch and execute them. Thus, when reference is made to a processor executing program code which is stored in a memory, this can include a software or a hardware implementation of these aspects.

As used herein, the term “program code” can refer to this aspect in both a hardware and a software context. In a hardware context, program code refers to firmware, which is the software embedded in a device's non-volatile memory that directly controls the operation of the hardware. Thus, firmware provides the instructions that a microcontroller or other embedded system executes to manage peripherals, sensors, and actuators, and it usually persists even when the device is powered off. In a software context, program code refers to a set of instructions written in a programming language that a processor or virtual machine executes, such as applications running on a computer or scripts interpreted by software platforms. Thus, the term “program code” herein can denote either device-specific firmware in hardware systems or general-purpose software in conventional computing environments.

As used herein, “haptic” refers to anything related to the sense of touch. In the context of the examples herein, haptic specifically describes systems or devices that use tactile feedback, such as vibrations, pressure, and/or force, to simulate physical sensations and enhance user interaction with digital or virtual environments.

As used herein, a “mediated social touch” (MST) is a form of touch-based communication that is transmitted through technology rather than occurring directly between people. MSTs utilize devices, including but not limited to haptic wearables, smartphones, and/or specialized interfaces, to simulate or convey the sensation of physical contact across a physical distance. MST extends the social and emotional functions of human touch, such as comfort, connection, or affection, into digitally mediated interactions where physical contact is otherwise impossible.

As used herein, a video conferencing platform or a VC platform is a digital system that enables real-time or near real-time communication between participants through video, audio, and often text chat, regardless of physical location. VC platforms are widely used in business, education, healthcare, and personal communication because they replicate many aspects of face-to-face interaction in a virtual setting.

Reference is made below to the drawings, which are not drawn to scale for ease of understanding, wherein the same reference numbers are used throughout different figures to designate the same or similar components. However, the following detailed description of certain examples will be better understood when read in conjunction with the appended drawings. To the extent that the figures illustrate diagrams of the functional blocks of various examples, the functional blocks are not necessarily indicative of the division between hardware components. Thus, for example, one or more of the functional blocks (e.g., processors or memories) may be implemented in a single piece of hardware (e.g., a general-purpose signal processor or random-access memory, hard disk, or the like). Similarly, the programs may be standalone programs, may be incorporated as subroutines in an operating system, may be functions in an installed software package, and the like. The various examples are not limited to the arrangements and instrumentality shown in the drawings.

The examples herein include apparatuses, computer systems, computer program products, and computer-implemented methods which integrate haptics into various applications, including but not limited to, teleconferencing, virtual reality, and/or gaming. For case of understanding, video conferencing is used throughout as a non-limiting example to show the functionality of the examples herein. Described herein are examples of an apparatus (e.g., a wearable device) which can be utilized to integrate haptic elements, specifically sensations mirroring types of human-to-human contact, into an online interactive computing experience (or session). Also described herein are methods of utilizing the apparatus in various computing systems, including but not limited to, teleconferencing systems. The examples herein also include a communication platform (e.g., VC application or platform) where program code executing on one or more processors can obtain input from a first user and deliver to a second user, via an example of the aforementioned apparatus, with is a face-wearable haptic device, MSTs. The examples herein also include program code executing on one or more processors which can be accessed by various systems (e.g., an API) to command the aforementioned face-wearable haptic device to, based on entry by a first user of the system, deliver MSTs to a second user of the system. These various systems can include virtual reality, augmented reality, extended reality, and/or gaming systems. In some examples, program code executing on one or more systems can deliver MSTs via the face-wearable haptic device based on actions by the wearer of the device itself.

In the examples herein, two or more users wearing an example of the apparatus described herein can send and receive tactile feedback, bi-directionally, remotely. In these examples, program code executing on the one or more processors, delivers the MSTs to the face of a user wearing the face-wearable haptic device, via the device. Hence, to deliver bi-directional social touch experience for users, the examples herein can include one or more of: 1) a haptic wearable device to target a specific body location (e.g., a face of the wearer); 2) a haptic-enabled VC application; and/or 3) a technical integration point to enable the integration of the VC application as well as other applications with the wearable device.

The apparatuses (specifically, wearable haptic devices), computer systems, computer program products, and computer-implemented methods described herein deliver haptic feedback, including vibrotactile feedback, a form of haptic feedback that uses controlled vibrations to convey information or simulate touch sensations to a user, and/or pneumatic feedback, touch-based feedback generated by controlling air pressure in a device to create physical sensations for the user. Specifically, the examples herein deliver MSTs as vibrotactile feedback and/or pneumatic feedback. The wearable haptic devices herein utilize actuators (like motors, piezoelectric elements, or linear resonant actuators) to generate vibrations of varying intensity, frequency, or patterns. The wearable haptic devices can also deliver or rescind compressed air through air tubes, chambers, or inflatable structures.

Human touch can be crucial in fostering emotional well-being. Utilization of the examples herein can benefit, for example, individuals who live far from their loved ones may feel lonely or detached from society including vulnerable groups, such as patients, the elderly, children, and people with physical limitations. Aspects of certain of the examples herein can enhance electronic communications in various contexts, including but not limited to, in VC environments and in multi-player gaming environments. The enhancements that aspects of the examples herein provide foster connectedness through digital touch. For example, integrating artificial touch with audio and video calling can create more engaging interactions in remote situations.

Although various MSTs can be simulated in various implementations of the examples herein, for illustrative purposes only, certain of the examples discussed herein deliver MSTs akin to tapping, touching, tickling, and kissing, including while communicating with a VC application. Certain examples herein include program code executing on one or more processors comprising a user interface for sending various tactile cues to users at a distance and devices to deliver these tactile movements cued. Providing these tactile sensations, for example, to enhance communication systems, could provide accessibility to content being transmitted for individuals with perception issues when the content is provided without these additional cues, including but not limited to individuals with visual impairments as well as neurodiverse individuals with learning differences such as ADHD. Utilization of the examples herein can both enhance the immersive digital experience and foster emotional support of the user. This haptic-enabled technology can serve as a complementary comfort intervention to enhance the human empathetic touch to those who are suffering from life-threatening diseases such as cancer and in treating psychotic disorders to enable a user to feel secure and safe since lack of touch can have negative effects on both physical and mental health. Utilization of aspects of the examples herein facilitates connections between individuals who are physically distant, which can be particularly helpful for individuals with limited mobility and those suffering from critical illness. Aspects of the examples herein can be integrated into a wide range of applications, including providing training guidance, such as offering immersive simulations that enhance learning and skill acquisition.

The examples herein are inextricably linked to computing, are directed to a practical application, and provide significantly more than existing I/O devices utilized to enable user data entry and data receipt from computing systems. These examples are inextricably tied to computing at least because they include or otherwise utilize a unique hardware element in the form of a wearable device comprising a face-worn haptic device (e.g., which can be integrated with a headset) to deliver as output additional data in the form of sensations akin to human contacts or touches. These data (e.g., touches, contacts) are systematically designed using vibrotactile and/or pneumatic actuated feedback which can be coupled with audio feedback and can be integrated with real-time or near real-time video to provide visual cues with the sensations. Examples of the output (e.g., touches, contacts) can include sensations such as tapping, touching, tickling, and/or kissing. The examples herein can include an application programming interface (API) which can be called by program code in various software implemented in a computing environment, including as services and microservices, which based on the calls can deliver to a user wearing the wearable device, the called sensations. Hence, the examples herein are inextricably tied to computing at least because they include the integration of a unique output device (e.g., an apparatus with an original hardware configuration) into various computer-implemented methods, computer program products, and computing systems in order to deliver additional output to system users.

The delivery of sensations by the examples herein is directed to a practical application. Touch is essential for building relationships, providing comfort and emotional support, and helping us to create a sense of community. It is a non-verbal manner in which sentiments can be expressed. These non-verbal communications can profoundly affect the meaning of the words that may accompany them. Many communications nowadays are handled through remote communication systems, both as cost saving measures and for other practical reasons. Contact and communication have been judged as essential to health but remote communications, because they are missing any contact portion, are often lacking as solutions for individuals who are experiencing isolation or loneliness. The examples herein are directed to providing a more complete communication experience on a digital platform by supplementing digital interactive systems with haptics which convey sensations as an additional output to a user. Specific practical applications for the haptic feedback generated and output to a user in the examples herein include haptic feedback in gaming, educational application, and in simulations, including to enhance user experiences in virtual reality (VR), augmented reality (AR), and extended reality (XR), as well as on in digital communication platforms. Aspects of the examples here can bring greater intimacy and realism to digital communication through the incorporation of tactile cues using MSTs to improve connectedness and togetherness regardless over any physical distance. As will be described in greater detail herein, users utilizing aspects of the examples herein can experience digital communication closer to face-to-face interactions, resulting in a more immersive experience and can express their emotions naturally, creating a sense of togetherness and alleviating the longing for physical touch.

The apparatuses, computer systems, computer program products, and computer-implemented methods described herein provide significantly more than existing virtual communication solutions because they integrate a human touch as output and provide a unique output device to deliver this sensation. Existing virtual communication solutions lack these elements. For example, current conferencing platforms, which are just one example of systems into which aspects of the examples herein can be integrated, despite physical distance, enable face-to-face interaction, allowing people to see and hear each other. The benefits of these existing approaches are also realized in the examples herein, e.g., utilizing video to deliver non-verbal cues (e.g., facial expressions and body language). But unlike the examples herein, the essential communication component of (human) touch is missing from these existing approaches. Meanwhile, the haptic feedback provided in the examples herein enables the examples herein to provide significantly more.

The apparatuses described herein also provide more than existing devices which integrate haptic feedback. Existing approaches to providing haptic feedback to a user engaged with a computing platform include mobile phones and wearables proximate to the upper body of the users. These existing wearables are not easily adopted in part because they are incompatible with existing technology platform (in contrast to the examples herein which can be integrated into a variety of existing platforms) and are often cumbersome and not affordable. Furthermore, these existing approaches do not include the focus of human touch specifically. The apparatuses described herein provide sensation on the face of the wearer of the device. Current mobile devices, such as phones and laptops, which are predominantly used for digital communication, are inadequate in providing tactile feedback at specific body locations where social touch is typically perceived (e.g., face and shoulders). Thus, the examples herein bridge this technological gap by providing a lightweight, compact, and user-friendly apparatus (and system) that enhances accessibility and practicality. As will be described in greater detail herein, program code executing on one or more processors, via a custom apparatus, simulates routine human touches while users are engaged in a virtual-type experience, including but not limited to communicating with one another user via a communication platform.

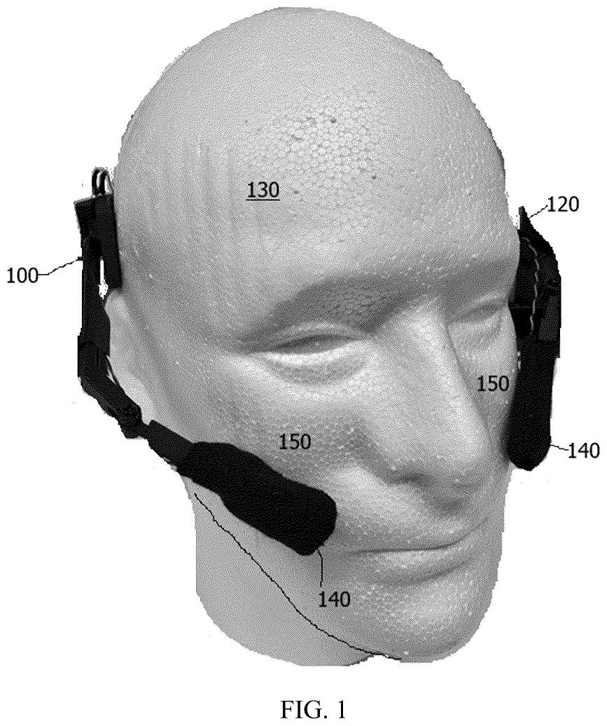

FIG. 1 illustrates an example of the aforementioned apparatus, which is a haptic device 100, a face-worn haptic device, which includes various aspects of the examples herein. The haptic 100 device size can be adjustable according to user size, worn on the head, e.g., like a head belt, or behind the car loops. This device 100 is easily deployable in existing technological environments and hence, easily accessible to users. As illustrated in FIG. 1, the haptic wearable device 100 has a headphone-like form factor, which can be seamlessly connected into various applications, including but not limited to, video calling applications. This face-worn haptic device 100 can deliver routine human touches, which are systematically designed using pneumatic or vibrotactile feedback and optionally audio feedback, while real-time video (e.g., of the present system or an existing system) utilized together with this device, provides visual cues. Hence, by utilizing this device 100, a user can augment his or her virtual communication experience with MSTs, making usage of the device 100 a multisensory experience.

As illustrated in FIG. 1, the device 100 comprises a wearable headpiece 120 which affixes the device to the head 130 of a user such that end effectors 140 can be attached to the headpiece 120 proximate to the check 150 of the wearer. An end effector 140 is a physical interface through which the user interacts with the system and receives feedback (e.g., tactile or force feedback). The end effector 140 is positioned proximate to the check, either in contact with the check 150 or adjacent to the check 150. As will be discussed herein, this positioning is dependent upon the type of actuators implemented in the end effectors 140. The positioning of the end effectors 140 on or adjacent to the cheek 150 of the user enables the device 100 to convey simulated sensations (e.g., resistance, texture, or vibration) generated by the device (based on program code executing on one or more processors providing data to trigger this feedback). Based on the placement of the end effectors 140, the device 100 is configured to target facial areas, more precisely, the checks 150. The device 100 can be designed to cover both sides of the face, enabling a sender to choose to deliver sensation to one or both cheeks. Materials can be selected to form the device 100 which are comfortable, portable, and do not muffle the haptic feedback. For example, foam or another dampening material can be utilized to direct the haptic feedback to the targeted area, the checks 150, via the end effectors 140, while the end effectors themselves are comprised of non-dampening materials. Thus, the device 100 can be manufactured using a combination of dampening and non-dampening materials. The end effectors 140 are configured to: 1) provide high resolution in a small form factor; and 2) enable a rich haptic, finger-like touch. The finger-like touch enables emotional support over a distance. The end effectors 140 deliver haptic feedback to the wearers of the device 100.

The device 100 can deliver haptic feedback in the form of vibrotactile feedback and/or force feedback, depending on the types of actuators and end effectors incorporated into the device 100. To that end, the end effectors 140 can include both vibration-based end effectors and/or pneumatic-based end effectors, to simulate an MST of the user (wearer). The integration of each type of end effector and its functionality within the examples herein is described below.

When included in the examples herein, the vibration-based end effector of the end effectors 140 conveys tactile feedback to the user primarily through controlled vibrations. Vibration-based end effectors are generally used to deliver small oscillations to simulate sensations such as texture, impact, friction, or alerts. Thus, integrating a vibration-based end effector into an end effector 140 of the device 100 can enable the device 100 to simulate a touch in an MST. Although a sensation delivered by a vibration-based end effector can feel less human than other end effector options, vibration-based end effectors can be easier to implement in hardware. Vibration-based end effectors deliver tactile feedback and to experience this feedback, a wearer of the device 100 should wear the device 100 such that the end effectors 140 are in contact with the cheeks 150 of the wearer.

When included in the examples herein, pneumatic-based end effectors utilize compressed air or gas to generate tactile sensations and force feedback for the user. The end effectors 140 can include pneumatic actuators (e.g., air bladders, soft chambers, or air jets) to inflate, deflate, and/or direct airflow to simulate touch, pressure, or texture. The touches generated by pneumatic-based end effectors are arguably more human-feeling than those generated by vibration-based end effectors but given the structural complexity of pneumatic-based end effectors, integrating pneumatic-based end effectors into examples of the apparatus described herein can be more complex. In contrast to vibration-based end effectors, pneumatic-based end effectors can provide feedback to a user when the device 100 into which they are incorporate positions the pneumatic-based end effectors adjacent to the cheeks 150 of the user rather than touching the cheeks 150 of the user 130. This is because when actuated (by an actuator), the pneumatic-based end effectors expand and contract and thus can make contact with the cheeks 150 of the user 130 when dictated by the feedback delivering the MST to the user 130.

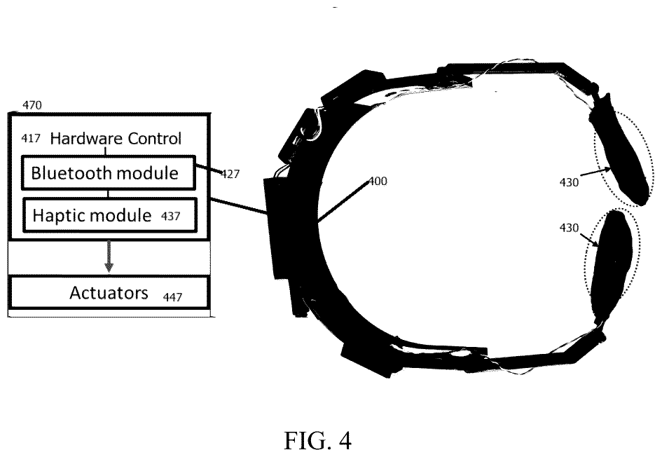

As will be discussed in reference to FIG. 4, the device 100 also includes hardware modules which can be self-contained. For example, the device 100 can comprise a microcontroller (e.g., a processor, a memory, and various peripherals) which can be selected to enable communications (e.g., Bluetooth) support and low power consumption. The communications module, a non-limiting example of which is a Bluetooth module, is connected to haptic modules (e.g., two haptic modules). Program code comprising the communications module controls the end effectors 140. The end effectors 140 of the device 100 can be two vibrotactile actuators (e.g., LRAs, ERMs) which are worn on both side of the user's face (at the user's cheeks) and are placed on an extended car-to-check (e.g., 3D-printed) arm. The hardware, discussed and illustrated in FIG. 4, can be enclosed within a (e.g., 3D-printed) case.

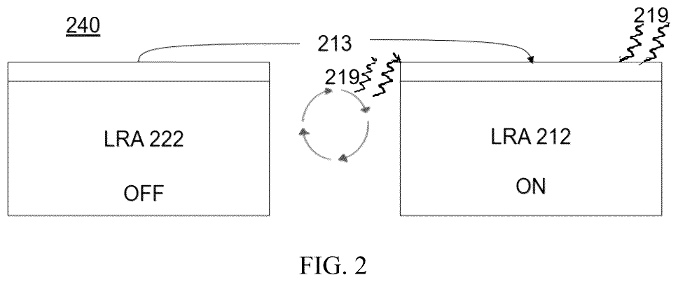

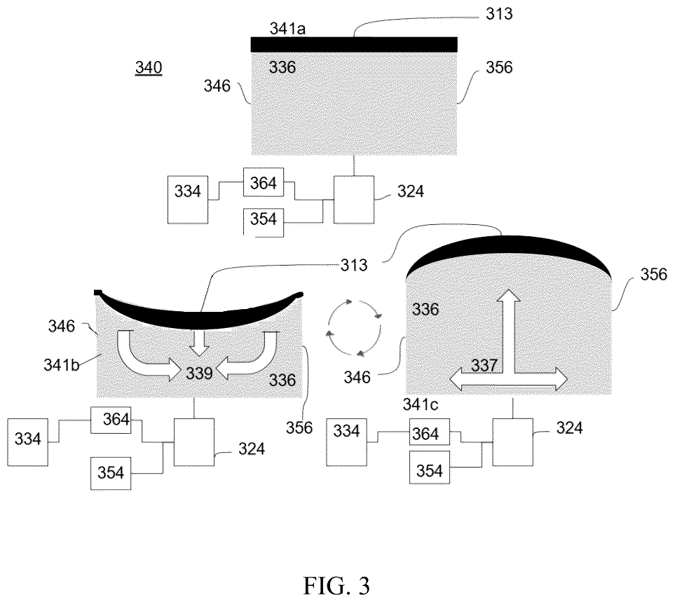

FIGS. 2-3 are examples of portions of a technical architecture for the end effectors 140 (FIG. 1). FIG. 2 illustrates vibrotactile actuator while FIG. 3 illustrates a pneumatic actuator. These actuators both produce haptic feedback, albeit differently and the resultant feedback is different in nature. While examples of the device which integrate vibrotactile actuators generate haptic feedback in the form of controlled vibrations on the skin (e.g., check), and the sensation comes from rapid oscillatory motion, the pneumatic haptic actuator air cavities, tubes, and flexible membranes to push against skin (e.g., check), creating pressure-based haptic feedback.

Certain examples of motors are provided herein but are provided just by way of example, for illustrative purposes only and not to suggest any limitations. For example, FIG. 2 illustrates vibrotactile actuator and this example includes linear resonant actuators (LRAs) and electromagnetic rotation motors (ERMs) are mentioned. However, various vibrotactile actuators can be integrated into examples of the device 100. Depending on the response time desired, different actuators can produce the functionality desired. Considerations in selecting the vibrotactile actuator can include heft, response time, size, cost, etc.

FIG. 2 illustrates a vibration-based end effector (e.g., FIG. 1, 140) which can be integrated into the device 100 of FIG. 1. In this non-limiting example, the end effectors 240 comprise two LRAs. An LRA is a type of vibration motor which can be integrated into a haptic device. FIG. 2 illustrated the functionality of an LRA in the device 100 (FIG. 1) so the first LRA 212 and the second LRA 222 can depict a common LRA in different states-when they are actuated and when they are not. The first LRA 212 is marked “LRA ON” to show that the actuator is actively vibrating 219, providing tactile feedback to the user, which is experienced through contact with the skin 213 of the user. The second LRA 222 is marked “LRA OFF” to illustrated that the actuator is inactive, so no vibration is being generated. LRAs are a non-limiting example of a motor which can be integrated into a (vibration-based) end effector 240 in the device 100 (FIG. 1) described herein. However, LRAs use a spring-mass system driven at its resonant frequency to produce precise, consistent vibrations with faster response times compared to alternatives hence utilizing LRAs to deliver MSTs with the haptic device 100 (FIG. 1) described herein can imbue this benefit into the device 100. For this reason, LRAs are prevalent in VR controllers.

Another type of motor which can be utilized in an (e.g., vibration-based) end effector 140 (FIG. 1) into the device 100 of FIG. 1 is an ERM. ERMs can be utilized in this device 100 because the size-to-power ratio allow for controlled amplitude and frequency. An ERM motor creates vibration by spinning a small, unbalanced weight attached to its shaft. As the shaft rotates, the off-center mass generates a shaking motion, which the user feels as vibration. This method produces a strong but less precise “rumble” effect that is slower to start and stop due to the inertia of the spinning mass. ERM motors are inexpensive and durable and are used generally where precise haptic feedback is not essential.

Returning the FIG. 2, the first LRA 212 and the second LRA 222 use a spring-mass system that moves linearly back and forth when driven at its resonant frequency to produce vibrations that are more precise, consistent, and easier to control compared to ERMs. LRAs also respond much faster, making them ideal for crisp, short haptic effects. Thus, LRAs can be utilized where fine-grained tactile feedback is desired.

FIG. 3 illustrates a pneumatic end effector 340 which can be integrated into the end effector 140 (FIG. 1) which works, as aforementioned, by using controlled air pressure to create tactile sensations through inflation, deflation, or airflow. Like FIG. 2, which shows LRAs in different states, FIG. 3 illustrates a pneumatic actuated end effector 340 in different states. Specifically, in FIG. 3, the pneumatic end effector 340 is illustrated in a first state 341a where it has not been actuated, in a second state 341b, where airflows are exiting the cavity 336 of the pneumatic end effector 340 (e.g., creating suction or negative pressure for a “kiss” MST), and in a third state 341c, where airflows are entering the cavity 336 of the pneumatic end effector 340 (e.g., creating positive pressure for a “tap” MST).

FIG. 3 illustrates a pneumatic end effector 340 positioned relative to the skin 313 of a user. As discussed above, examples of the device 100 (FIG. 1) which incorporate pneumatic end effectors can be positioned adjacent to the cheek(s) of a user (or in contact with the checks of the user) because the pneumatic end effector 340 will expand and contract as actuated. As illustrated in FIG. 3, the pneumatic end effector 340 includes an air tube 324, which delivers compressed air from a pump or reservoir 334 into the end effector 340. The movement of the air flow in the end effector 340 can be guided by a negative pressure valve 354 and a positive pressure valve 364. This air flows into (and out of) an air cavity 336, a chamber designed to expand (e.g., third state 341c) or contract (e.g., second state 341b) as pressure changes. The cavity 336 is enclosed by two layers: a non-flexible layer 346, which provides structural support and prevents unwanted expansion, and a flexible layer 356, which deforms outward when the cavity 336 is pressurized. When air is pumped through the tube 324 into the cavity 336 (air flow 337), the flexible layer 356 bulges or changes shape, creating a physical force that the user feels on their skin 313. A user will also experience a sucking (related to the kiss MST) feeling on the user's skin when air is pulled out of the cavity 336 into the tube 324 into (air flow 339). Releasing the air causes (air flow 339) the flexible layer 356 to return to its resting state. By precisely controlling airflow, the pneumatic end effectors 340 simulate varying levels of pressure, texture, and/or contact.

FIG. 4 is a system (e.g., technical architecture) 470 diagram of various hardware and/or software components comprising the device 100 (FIG. 1). To show where the hardware is integrated, a top-view of the device 400 (e.g., FIG. 1, 100) is also provided. Connectivity of the device 100 to a VC application or other system can be accomplished via various methods, including but not limited to, Bluetooth. For illustrative purposes only, Bluetooth connectivity is illustrated in the example in FIG. 4. Hence, the device 100 of FIG. 1 (e.g., device 400) can be understood as a Bluetooth operated face wearable haptic device aligned to the checks of a user. But returning to FIG. 4, the system 470 components comprising the haptic device described herein can include hardware control 417, a Bluetooth module 427 (which can be swapped with a communications module utilizing a different technology), a haptic module 437, and actuators 447. While the end effectors (e.g., FIG. 1, 140), discussed above provide tactile feedback and/or simulates sensations (e.g., delivers MSTs) the actuators 447 in the haptic device (e.g., motors, and/or pneumatic elements) generate the forces, vibrations, motions, and/or suction effect (e.g., the kiss MST) that the end effectors convey to the user. The actuators 447 drive the movement and resistance of the end effectors, allowing the user to feel the MSTs. The hardware control 417 comprises at least one processor (e.g., a microcontroller). In the hardware controller (e.g., hardware control 417), the Bluetooth module 427 and the haptic module 437 interact to enable the device 100 (FIG. 1) to obtain and deliver wireless, responsive tactile feedback.

In the example in FIG. 4, the Bluetooth module 427 acts as the communication interface, receiving signals or commands for example, from a connected device, such as a smartphone, computer, and/or game console. These signals can include instructions for when, where, and how the haptic module 437 should activate (e.g., to produce vibrations, pulses, or force feedback). Some examples herein can include multiple haptic modules 437, one controlling each end effector in the device. The program code in the hardware control 417 executing on the microcontroller (e.g., of the hardware control 417) interprets the Bluetooth data and sends control signals to the haptic module 437, which then drives its actuators 447 (motors, vibration elements, and/or other tactile devices) to produce the intended sensations (e.g., MSTs). This interaction enables a user (a wearer of the device 100) to feel real-time feedback that corresponds to events in a virtual or remote environment, creating an immersive and interactive experience.

As illustrated in FIG. 4, in some examples, the hardware control modules (e.g., hardware control 417) are self-contained, and the hardware can connect to software using Bluetooth. The haptic device 100 (FIG. 1) can connect seamlessly to the software modules because Bluetooth-operated devices can connect to a mobile phone or laptop.

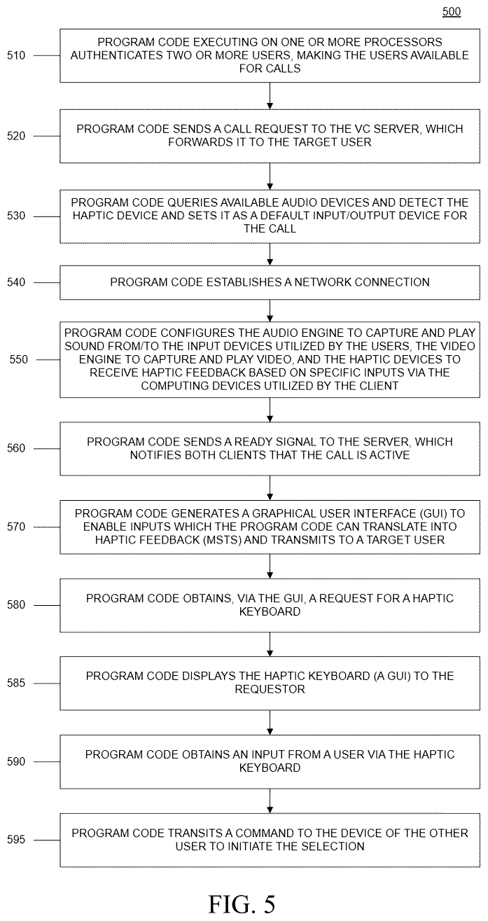

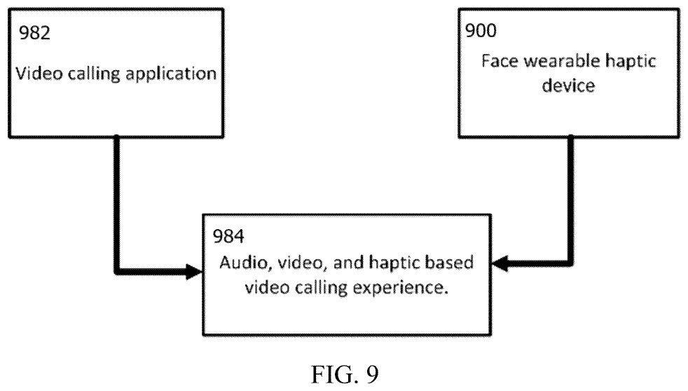

As discussed earlier, not only do certain of the examples herein include a haptic device (e.g., FIG. 1, 100), certain of the examples herein integrate usage of this device into a telecommunications platforms, specifically a VC application. FIG. 5 is a workflow 500 which provides a general overview of the functionality of certain of these examples. As the workflow 500 is described, FIG. 9 provides a general overview of elements in the technical architecture which enable this workflow, specifically, the face wearable haptic device 900 (e.g., FIG. 1, 100), a VC application 982, and an audio, video, and the resultant haptic based video calling experience 984 generated by the program code. As illustrated in FIG. 9, elements of the VC application and the device 900 enable the experience 984.

Referring to FIG. 5, program code executing on one or more processors (a VC application) authenticates two or more users with a VC server or cloud service, making the users available for calls (510). When a user initiates a call via the user's personal computing device (upon which the user was authenticated), the program code sends a call request to the VC server, which forwards it to the target user (520). Because each user's personal device communicates with the haptic device (e.g., FIG. 1, 100), which comprises a communications (e.g., Bluetooth connection), through the operating system's Bluetooth stack, the program code can query available audio devices and detect the haptic device 100 and sets it as a default input/output device for the call (530). Once the call request is accepted, the program code establishes a network connection (540). This can include the program code and server exchanging information about IP addresses, ports, audio codes, encryption keys, and quality-of-service preferences so that both callers can send and receive audio and video streams efficiently. The program code configures the audio engine to capture and play sound from/to the input devices utilized by the users, the video engine to capture and play video, and the haptic devices to receive haptic feedback based on specific inputs via the computing devices utilized by the client (550). After the program code establishes the network session and configures audio, video, and haptic routing, the program code sends a ready signal to the server, which notifies both clients that the call is active (560). The audio and video streams begin transmitting in real-time over the Internet, and the program code continuously monitors latency, packet loss, and Bluetooth connection stability. If the headset haptic device disconnects, the program code can automatically switch to an alternative device or prompt the user to reconnect.

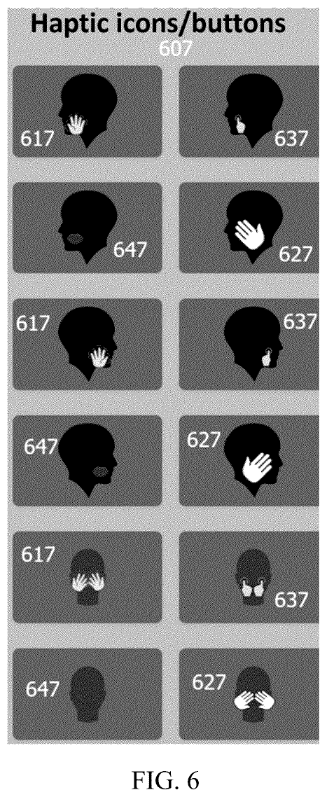

When the session is operable, the program code generates a graphical user interface (GUI) of controls to enable inputs that the program code can translate into haptic feedback (MSTs) and transmit to a target user (570). The program code obtains, via the GUI, a request for a haptic keyboard (580). FIG. 6 is an example of a haptic keyboard 607, the program code can display responsive to this request. FIG. 7 illustrates the interface 703 of the VC application in which the user can select the haptic feedback 713 button to trigger the program code to populate the keyboard 607 (FIG. 6) on the screen.

Returning to FIG. 5, based on obtaining this request (which as illustrated in FIG. 7 is the selection of the user of a haptic button 713), the program code displays the haptic keyboard (a GUI) to the requestor (585). The program code obtains an input from a user via the haptic keyboard (590). The program code transits a command to the device of the other user so that this user can initiate the selection (595). In some examples, the user who receives the haptic feedback can confirm receipt via the interface. In some examples, the interface 703 where a user can select haptic feedback and the haptic keyboard 607 can be displayed in the same client interface.

As illustrated in FIG. 6, the haptic keyboard 607 includes emoticons for specific haptic feedback. In this example, the specific feedback includes a gentle touch 617, a tap 627, a tickle 637, and a kiss 647. Each option is available for selection one or more cheeks upon which the other user will receive these touches. The program code (via the device 100) delivers the touches as a combination of vibrations and pressure. The haptic module(s) has been trained to produce each specific MST in a pre-defined manner based on the combination of vibration and/or pressure delivered by the end effectors (via the actuator, upon receipt of the command by the controller, via the Bluetooth module, from the program code of the VC application executing on one or more processors in a VC system).

The haptic device (e.g., FIG. 1, 100) described herein is configured to deliver multi-mode tactile feedback to a wearer. Pressure and vibration both can produce using pneumatic actuation. The pneumatic actuation integrated into the exampled herein provides realistic human-like touches (e.g., taps, touch (gentle and firm), tickles, grabs, and kisses). To integrate MSTs into existing applications in a user friendly and accessible manner, including integrating into video calling applications, the haptic device 100 (FIG. 1) is configured to be a lightweight, compact, and face-worn form factor. When integrated into various applications, rather than provide unlimited MSTs, various MSTs are pre-configured for the specific functionality of the application utilizing the MSTs. Thus, the VC application contemplated for use with the haptic device 100 (FIG. 1) includes a set of MSTs to enhance the video conferencing experience. To enable the bi-directional MST communication described herein, the pre-defined human-like touch stimuli was generated (to be pre-set within the system) using vibrotactile feedback and/or pneumatic feedback and, optionally, audio cues to allow users to experience a richer sensation of social touch.

Thus, as illustrated in FIGS. 5-7, when utilizing aspects of the examples herein in a VC application or system, the user can also utilize audio and visual feedback in existing video call, enabled by the program code. And the haptic device 100 enables the session to include tactile feedback. This tactile feedback can be integrated into existing video call applications to incorporate depth.

In some examples, in advance of utilizing the haptic device 100 (FIG. 1) for any system which incorporates the feedback experienced by wearers of the device 100, the program code defines the pre-defined MSTs, which can be understood as multi-modal touch stimuli. In order to design the haptic feedback utilized in the examples herein, program code executing on one or more processors obtained data from sensors to determine parameters for the MSTs desired for implementation. Using MSTs delivered as vibrotactile feedback as an example, the program code, by monitoring, with sensors, collected data from repetitive touches to determine parameters related to frequency, vibrotactile envelope, intensity, time, and composite waveforms for each MST (e.g., gesture). A vibrotactile envelope refers to the overall shape or profile that defines how a haptic signal (e.g., vibration and/or pressure) changes over time. A vibrotactile envelope controls the intensity, duration, and temporal dynamics of a touch signal. For example, an MST of gentle tap could use a short, sharp envelope with a quick rise and decay, while a comforting stroke could use a smoother, longer envelope with gradual changes in intensity. By determining the shapes of these envelopes, the program code can enable the pre-defined MSTs to feel more natural, expressive, and emotionally meaningful. Similar monitoring can also be employed to determine the parameters of pneumatic feedback, including but not limited to, air pressure, airflow rate, volume/displacement, frequency/modulation, duration, contact area, and/or response time.

In the examples herein, the program code translates the values obtained by sensors (and other input and monitoring devices) into parameters which can be effectuated via the haptic device (e.g., vibration, pressure, temperature, etc.), as haptic feedback (e.g., vibrotactile, pneumatic) so a user can experience an MST. Thus, program code executing on one or more processors utilizes these parameters to define the MSTs. When a user selects a given touch for delivery, e.g., to another (target) user, program code (e.g., of the haptic module(s) in the device 100) provides these parameters to actuators in the haptic device of the target user, which the actuators utilize to deliver the touches through the end effectors.

To capture and define certain MSTs, program code executing on one or more processors can obtain haptic stimulus combined with auditory cues so that the auditory effects of the MSTs can be integrated into the MSTs. For examples, the aforementioned “kiss” MST can include an auditory element. To incorporate this audio element into an MST, the program code can obtain a retain a pre-captured audio clip of the sound associated with kissing. For tapping, which can be one of the pre-defined MSTs, the sound of tapping. The program code blends the sounds with relevant haptic (e.g., vibrotactile, pneumatic) feedback. For example, the program code can utilize a similar time, amplitude, envelope, and composite waveform to render the vibration in the vibrotactile feedback of an MST. Thus, when the device 100 delivers the tactile feedback of an MST via one or more end effector, the auditory device the user is utilizing with the device 100 (which can be an integrated component), delivers the audio to the user.

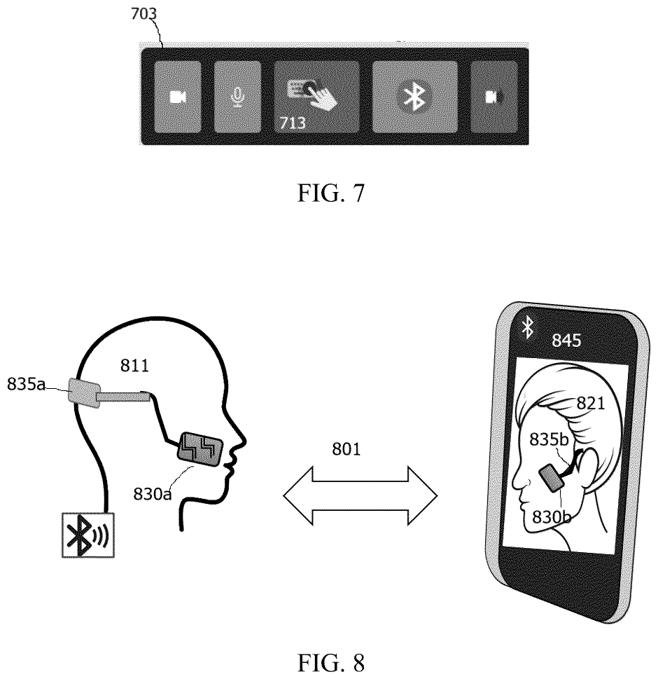

Referring to FIG. 8, certain of the examples herein include a computer system with a haptic device (which delivers MSTs), where the target of the MSTs (the wearer of the device) experiences feedback that includes elements which are tactile, audio, and visual. As discussed above, the MST can include both an audio elements and a vibrotactile or pneumatic element. The visual element is delivered by the program code concurrently with the tactile and audio elements because, returning to FIG. 8, when a first user 811 and a second user 821 communicate via a remote communication system 801, each wearing an example of the haptic device 835a-835b described herein (e.g., FIG. 1, 100), which includes end effectors 830a-830b to deliver audio and haptic (e.g., vibrotactile, pneumatic) elements comprising an MST. In this example, a first user 811 is at a given location while the second user 821 is at a location which is remote from the first user 811, so the second user 821 appears to the first user 811 in a GUI on a (personal) computing device (e.g., client) 845 of the first user 811. In this example, the first user 811 is the target of MSTs sent by the second user 821. The first user 811 experiences visual feedback from the second user 821 based on viewing the facial expressions of the second user, in real-time or near-real time (via video) in the GUI 845. The visual feedback is contemporaneous with the first user 811 receiving, via the audio output selected by the first user 811 (not pictured), audio associated with the specific stimuli and tactile cues.

The examples herein include computer systems (which can be embodied partially or entirely in devices), computer-implemented methods, and computer program products, for delivery of a mediated social touch (MST). Certain of these examples include a haptic device which includes a memory, one or more processors in communication with the memory (as aforementioned, these elements can be embodied in hardware and/or software), one or more actuators in communication with one or more processors, one or more end effectors, wherein each end effector is communicatively coupled to at least one actuator of the one or more actuators, and a housing to contain the memory, at least one processor of the one or more processors, and the one or more actuators. The housing can include a frame to position each end effector of the one or more end effectors proximate to a cheek of a wearer of the device, where the user is the wearer of the device, and wherein the computer system is configured to perform a method. The method can include program code (which can be embodies in firmware and/or software) obtaining an instruction to deliver the MST to the user and the program code controlling at least one actuator of the one or more actuators to control at least one end effector of the one or more end effectors to deliver haptic feedback to the user, where the haptic feedback comprises the MST.

In some examples, the haptic feedback vibrotactile feedback and/or pneumatic actuated tactile feedback.

In some examples, program code obtaining the instruction to deliver the MST to the user comprises utilizing accessing firmware embedded the memory, where the memory comprises a non-volatile of a microcontroller.

In some examples, program code controlling the at least one actuator comprises the program code querying the memory, based on the instruction, to identify the haptic feedback comprising the MST. The memory comprises a data resource mapping various MSTs to specific haptic feedback.

In some examples, where the instruction comprises a target location for the MST, wherein the delivering haptic feedback to the user comprises controlling a given end effector proximate to the target location at the at least one end effector to deliver the haptic feedback to the user.

In some examples, the target location is selected from the group consisting of: a right cheek of the user, a left cheek of the user, and/or both cheeks of the user.

In some examples, the MST is selected from the group consisting of: a tap, a touch, a tickle, and a kiss.

Some examples also include an audio output device communicatively coupled to the one or more processors. Thus, in some examples, contemporaneously with controlling the at least one actuator to deliver the haptic feedback, the program code controls the audio output device to deliver specific audio feedback; the MST further comprises the specific audio feedback.

In some examples, the memory and the at least one processor comprise a microcontroller.

In some examples, the haptic device further comprises a communications module communicatively coupled to the one or more processors and the program code obtains the instruction via the communications module.

In some examples, one or more end effectors comprise end effectors selected from the group consisting of: vibration-based end effectors, pneumatic-based end effectors, and a combination of vibration-based end effectors and pneumatic-based end effectors.

In some examples, the haptic device is wearable and further comprises at least one of a head belt or behind the ear loops to enable the user to wear the device on a head of the user. This head belt can be adjustable.

In some examples, the one or more processors comprise at least one processor physically located in a remote location from the device.

In some examples the at least one processor physically located in the remote location is a processor executing program code comprising a virtual conferencing (VC) application, wherein the instruction is from the VC application.

In some examples, the instruction is from the VC application is based on a request from a remote user of the VC application engaging in an active instance of the VC application with the user via the processor executing the program code comprising the virtual conferencing (VC) application.

In some examples, the one or more end effectors are each in physical contact with at least one cheek of the user.

In some examples, program code initiates a communication instance between respective computing clients of the user and of a remote user. The program code generates a first graphical user interface comprising a haptic feedback option. The program code displays an instance of the first graphical user interface on each of the computing clients. The program code obtains, from the remote user, via the instance of the first graphical user interface displayed in the computing client of the remote user, a selection of the haptic feedback option. The program code generates a second graphical user interface comprising a dashboard of MSTs for selection by the remote user via the computing client of the remote user. The program code displays the second graphical user interface on the client computing device of the remote user. The program code obtains, via the second graphical user interface, a request for an MST via the selection by the remote user in the second graphical user interface. Based on the request, the program code generates the instruction to deliver the MST to the user.

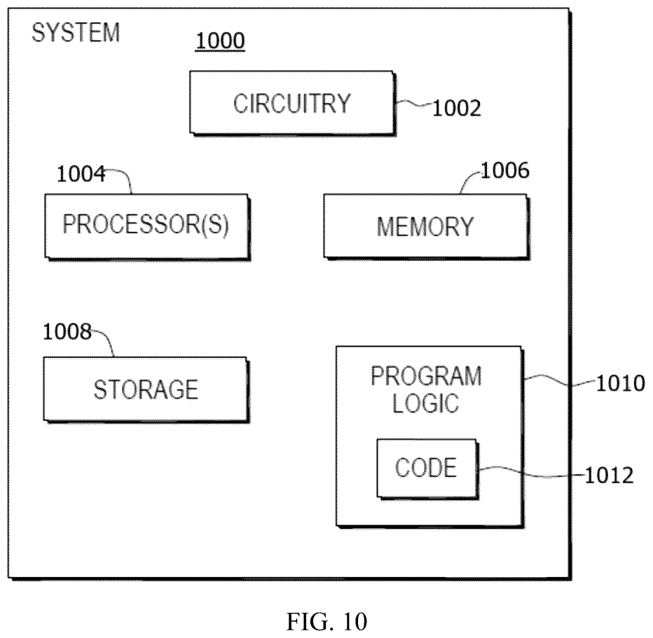

FIG. 10 illustrates a block diagram of a resource 1000 in computer system, such as, which is part of the technical architecture of the sequencing system described herein. Returning to FIG. 10, the resource 1000 may include a circuitry 1002 that may in certain embodiments include a microprocessor 1004. The computer system 1000 may also include a memory 1006 (e.g., a volatile memory device), and storage 1008. The storage 1008 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 1008 may comprise an internal storage device, an attached storage device and/or a network accessible storage device. The storage device 1008 can store the existing sample indices which the program code accesses to compare to automatically detected sample indices. The system 1000 may include a program logic 1010 including code 1012 that may be loaded into the memory 1006 and executed by the microprocessor 1004 or circuitry 1002. As discussed above, various aspects of FIG. 5 can be encapsulated in program code 1012.

In certain embodiments, the program logic 1010 including code 1012 may be stored in the storage 1008, or memory 1006. In certain other embodiments, the program logic 1010 may be implemented in the circuitry 1002. The program logic 1010 in the examples herein can be implemented in the memory 1006 and/or the circuitry 1002. The program logic 1010 may include the program code discussed in this disclosure that facilitates the reconfiguration of elements of various computer networks, including those in various figures.

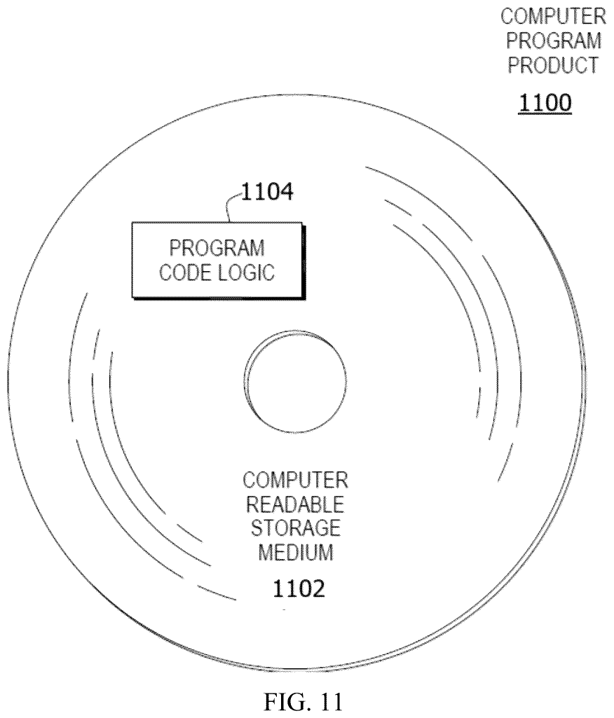

Using the processing resources of a resource 1000 to execute software, computer-readable code or instructions, does not limit where this code can be stored. Referring to FIG. 11, in one example, a computer program product 1100 includes, for instance, one or more non-transitory computer readable storage media 1102 to store computer readable program code means or logic 1104 thereon to provide and facilitate one or more aspects of the technique.

Examples herein include computer-implemented methods, computer systems, computer program products, and apparatuses for integrating MST delivery into computing environments.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using an appropriate medium, including but not limited to wireless, wireline, optical fiber cable, RF, etc., or any suitable combination of the foregoing. The computer-readable medium does not include a transitory, propagating signal.

Computer program code for carrying out operations for aspects of the technique may be written in any combination of one or more programming languages, including an object oriented programming language, such as Java, Smalltalk, C++ or the like, and conventional procedural programming languages, such as the “C” programming language, PHP, ASP, assembler or similar programming languages, as well as functional programming languages and languages for technical computing (e.g., Matlab). The program code may execute entirely on the user's computer, partly on the user's computer, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Furthermore, more than one computer can be used for implementing the program code, including, but not limited to, one or more resources in a cloud computing environment.

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions, also referred to as software and/or program code, may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technique. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally, or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique.

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described to best explain various aspects and the practical application, and to enable others of ordinary skill in the art to understand various embodiments with various modifications as are suited to the particular use contemplated.

What is claimed is:

1. A computer system for delivery of a mediated social touch (MST) to a user, comprising:
a haptic device comprising:
a memory;
one or more processors in communication with the memory;
one or more actuators in communication with one or more processors;
one or more end effectors, wherein each end effector is communicatively coupled to at least one actuator of the one or more actuators; and
a housing to contain the memory, at least one processor of the one or more processors, and the one or more actuators, the housing comprising a frame to position each end effector of the one or more end effectors proximate to a cheek of a wearer of the device, wherein the user is the wearer of the device, and wherein the computer system is configured to perform a method, said method comprising:
obtaining, by the one or more processors, an instruction to deliver the MST to the user; and
controlling, by the one or more processors, at least one actuator of the one or more actuators to control at least one end effector of the one or more end effectors to deliver haptic feedback to the user, wherein the haptic feedback comprises the MST.

2. The computer system of claim 1, wherein the haptic feedback is selected from the group consisting of: vibrotactile feedback and pneumatic feedback.

3. The computer-system of claim 1, wherein obtaining the instruction to deliver the MST to the user comprises accessing firmware embedded the memory, wherein the memory comprises a non-volatile of a microcontroller.

4. The computer system of claim 1, wherein controlling the at least one actuator comprises:
querying, by the one or more processors, the memory, based on the instruction, to identify the haptic feedback comprising the MST, wherein the memory comprises a data resource mapping various MSTs to specific haptic feedback.

5. The computer system of claim 1, where the instruction comprises a target location for the MST, wherein the delivering haptic feedback to the user comprises controlling a given end effector proximate to the target location at the at least one end effector to deliver the haptic feedback to the user.

6. The computer-system of claim 5, wherein the target location is selected from the group consisting of: a right cheek of the user, a left cheek of the user, and both cheeks of the user.

7. The computer-system of claim 1, wherein the MST is selected from the group consisting of: a tap, a touch, a tickle, and a kiss.

8. The computer-system of claim 1, further comprising:
an audio output device communicatively coupled to the one or more processors, the method further comprising:
contemporaneously with controlling the at least one actuator to deliver the haptic feedback, controlling the audio output device to deliver specific audio feedback, wherein the MST further comprises the specific audio feedback.

9. The computer-system of claim 1, wherein the memory and the at least one processor comprise a microcontroller.

10. The computer-system of claim 1, wherein the haptic device further comprises a communications module communicatively coupled to the one or more processors, wherein the obtaining the instruction is via the communications module.

11. The computer-system of claim 1, wherein the one or more end effectors comprise end effectors selected from the group consisting of: vibration-based end effectors, pneumatic-based end effectors, and a combination of vibration-based end effectors and pneumatic-based end effectors.

12. The computer system of claim 1, wherein the haptic device is wearable and further comprises at least one of a head belt or behind the ear loops to enable the user to wear the device on a head of the user.

13. The computer system of claim 1, wherein the one or more processors comprise at least one processor physically located in a remote location from the device.

14. The computer system of claim 13, wherein the at least one processor physically located in the remote location is a processor executing program code comprising a virtual conferencing (VC) application, wherein the instruction is from the VC application.

15. The computer system of claim 14, wherein the instruction is from the VC application is based on a request from a remote user of the VC application engaging in an active instance of the VC application with the user via the processor executing the program code comprising the virtual conferencing (VC) application.

16. The computer system of claim 1, wherein the one or more end effectors are each in physical contact with at least one cheek of the user.

17. A computer-implemented method for delivery of a mediated social touch (MST) to a user comprising:
obtaining, by one or more processors, an instruction to deliver the MST to the user;
querying, by the one or more processors, a data repository, to identify haptic feedback comprising the MST, wherein the data repository comprises mappings of various MSTs, wherein the various MSTs comprise the MST, to specific haptic feedback; and
controlling, by the one or more processors, a haptic device comprising one or more end effectors positioned proximate to at least one cheek of the user, wherein the user is wearing the haptic device, to deliver the haptic feedback comprising the MST to the user via a portion of the one or more end effectors.

18. The computer-implemented method of claim 17, wherein obtaining the instruction to deliver the MST to the user comprises:
initiating, by the one or more processors, a communication instance between respective computing clients of the user and of a remote user;
generating, by the one or more processors, a first graphical user interface comprising a haptic feedback option;
displaying, by the one or more processors, an instance of the first graphical user interface on each of the computing clients;
obtaining, by the one or more processors, from the remote user, via the instance of the first graphical user interface displayed in the computing client of the remote user, a selection of the haptic feedback option;
based on obtaining the selection, generating, by the one or more processors, a second graphical user interface comprising a dashboard of MSTs for selection by the remote user via the computing client of the remote user;
displaying, by the one or more processors, the second graphical user interface on the client computing device of the remote user;
obtaining, by the one or more processors, via the second graphical user interface, a request for an MST via the selection by the remote user in the second graphical user interface; and
based on the request, generating, by the one or more processors, the instruction to deliver the MSTs to the user.

19. A computer program product for delivery of a mediated social touch (MST) to a user, the computer program product comprising:
one or more computer readable storage media and program instructions collectively stored on the one or more computer readable storage media readable by at least one processing circuit to:
obtain an instruction to deliver the MST to the user;
query a data repository, to identify haptic feedback comprising the MST, wherein the data repository comprises mappings of various MSTs to specific haptic feedback; and
control a haptic device comprising one or more end effectors positioned proximate to at least one cheek of the user, wherein the user is wearing the haptic device, to deliver the haptic feedback comprising the MST to the user via a portion of the one or more end effectors.

20. The computer program product of claim 19, the program instructions collectively stored on the one or more computer readable storage media readable by the least one processing circuit to obtain the instruction to deliver the MST to the user comprising instructions to:
initiate a communication instance between respective computing clients of the user and of a remote user;
generate a first graphical user interface comprising a haptic feedback option;
display an instance of the first graphical user interface on each of the computing clients;
obtain, from the remote user, via the instance of the first graphical user interface displayed in the computing client of the remote user, a selection of the haptic feedback option;
generate a second graphical user interface comprising a dashboard of MSTs for selection by the remote user via the computing client of the remote user;
display the second graphical user interface on the client computing device of the remote user;
obtain, via the second graphical user interface, a request for an MST via the selection by the remote user in the second graphical user interface; and
based on the request, generate the instruction to deliver the MST to the user.
